(19) United States
(12) Patent Application Publication
(10) Pub. No.: US 2002/0021881 A1
(43) Pub. Date: Feb. 21, 2002

(54) Single-piece alignment frame for optical fiber arrays

(76) Inventor: Dan A. Steinberg, Blacksburg, VA (US)

Correspondence Address: JONES VOLENTINE, L.L.C., SUITE 150, 12200 SUNRISE VALLEY DREVE, RESTON, VA, 20191, US

(21) Appl. No.: 09/825,990

(22) Filed: Apr. 5, 2001

Related U.S. Application Data
(60) Provisional application No. 60/194,916, filed on Apr. 5, 2000.

(51) Int. Cl. G02B 6/36

(52) U.S. Cl. 385/137

(57) ABSTRACT

An optical device includes a single-piece alignment frame and has at least one opening therein. The opening is adapted to receive a waveguide alignment member.

Advantageously, the optical device enables while passive alignment of optical waveguides substantially avoiding run-out error and fiber insertion problems.

### CROSS-REFERENCES TO RELATED APPLICATIONS

The present invention claims priority from U.S. Provisional Patent Application No. 60/194,916, filed Apr. 5, 2000 and entitled “2-d fiber array with 1-d fiber arrays in an etched frame.” The disclosure of this priority application is specifically incorporated by reference herein.

### FIELD OF THE INVENTION

The present invention relates generally to optical waveguide communications, and particularly to an optical fiber array.

### BACKGROUND OF THE INVENTION

The increasing demand for high-speed voice and data communications has led to an increased reliance on optical communications, particularly optical fiber communications. The use of optical signals as a vehicle to carry channeled information at high speeds is preferred in many instances to carrying channeled information at other electromagnetic wavelengths/frequencies in media such as microwave transmission lines, co-axial cable lines and twisted pair transmission lines. Advantages of optical media are, among others, high-channel capacity (bandwidth), greater immunity to electromagnetic interference, and lower propagation loss. In fact, it is common for high-speed optical communication systems to have signal rates in the range of approximately several Giga bits per second (Gbit/sec) to approximately several tens of Gbit/sec.

One way of carrying information in an optical communication system, for example an optical network, is via an array of optical fibers. Ultimately, the optical fiber array may be coupled to another array of waveguides, such as another optical fiber array, or a waveguide array of an optoelectronic integrated circuit (OEIC). In order to assure the accuracy of the coupling of the fiber array to another waveguide array, it becomes important to accurately position each optical fiber in the array.

One technique to carry out the alignment between a fiber array and another waveguide array is by active alignment followed by bonding. While the accuracy of such a technique may be acceptable, the active alignment techniques are difficult, labor intensive and expensive; thus these techniques not well suited for large-scale manufacturing.

Silicon waferboard technology has also been used to achieve passive alignment in optical fiber communication systems. While silicon waferboard shows promise in the fabrication of optical fiber arrays, conventional uses of silicon waferboard to passively align an array of optical fibers have also met with mixed results. The drawbacks to conventional silicon waferboard passive alignment of optical fiber arrays include difficulty inserting fibers into openings and stack-up tolerance. Problems with fiber insertion can hinder mass production and reliability. Run-out error (also referred to as stack-up error) is the term given to the additive nature of the tolerances of individual components or pieces in a structure. Run-out error can adversely impact alignment of fibers.

Accordingly, what is needed is a structure, which overcomes the drawbacks of conventional optical fiber arrays as described above.

### SUMMARY OF THE INVENTION

According to an illustrative embodiment of the present invention, an optical device includes a single-piece alignment frame having at least one opening therein. A waveguide alignment member is disposed in each opening.

According to an illustrative embodiment of the present invention, an optical device includes a single-piece alignment frame and has at least one opening having grooves, which receive optical fibers. A waveguide alignment member is disposed in each opening.

According to yet another illustrative embodiment of the present invention, a single piece alignment frame has at least one opening therein. The opening(s) have at least one alignment fiducial. A waveguide alignment member is disposed in each opening.

Advantageously, the optical device of the present invention enables passive alignment of optical waveguides while substantially avoiding run-out error and fiber insertion problems.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a front view of a two-dimensional fiber array according to an illustrative embodiment of the present invention.

FIG. 2 is a front view of a two-dimensional fiber array according to an illustrative embodiment of the present invention.

FIG. 3 is a front view of a two-dimensional fiber array according to an illustrative embodiment of the present invention.

FIGS. 4(a)-4(c) are cross-sectional views of waveguide arrays that may be disposed in single-piece alignment frames in accordance with an exemplary embodiment of the present invention.

FIGS. 4(d) and 4(e) are cross-sectional views of waveguide alignment members disposed in openings in single-piece alignment frames according to illustrative embodiments of the present invention.

FIG. 5(a) is a front view of a two-dimensional fiber array according to an exemplary embodiment of the present invention.

FIG. 5(b) is a top view of a waveguide array according to an illustrative embodiment of the present invention.

FIGS. 6(a) and 6(b) are front views of two-dimensional fibers arrays including alignment fiducials according to an illustrative embodiment of the present invention.

FIG. 7(a) is a front view of a single-piece alignment frame including positioning pits in accordance with an exemplary embodiment of the present invention.

FIG. 7(b) is a side view of a waveguide array optically coupled to a passive element frame in accordance with an exemplary embodiment of the present invention.

FIG. 8 is a front view of a single-piece alignment frame in accordance with an exemplary embodiment of the present invention.

FIG. 9 is a front view of a single-piece alignment frame in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to an optical device including a single-piece alignment frame having at least one opening therein. The opening is adapted to receive a waveguide alignment member. Illustratively, the waveguide alignment member has optical fibers disposed thereon, which form a substantially one dimensional fiber array. In exemplary embodiments in which the single-piece alignment frame includes more than one opening, and each opening has a waveguide alignment member disposed therein, a substantially two dimensional (2D) fiber array is realized. Advantageously, the optical device of the present invention enables accurate alignment of optical waveguides substantially without the disadvantage of the run-out error. Moreover, the waveguides are disposed in the waveguide alignment member thereby substantially avoiding problems associated with the insertion of waveguides in conventional waveguide arrays. Finally, many optical fibers may be inserted into the single piece alignment frame simultaneously.

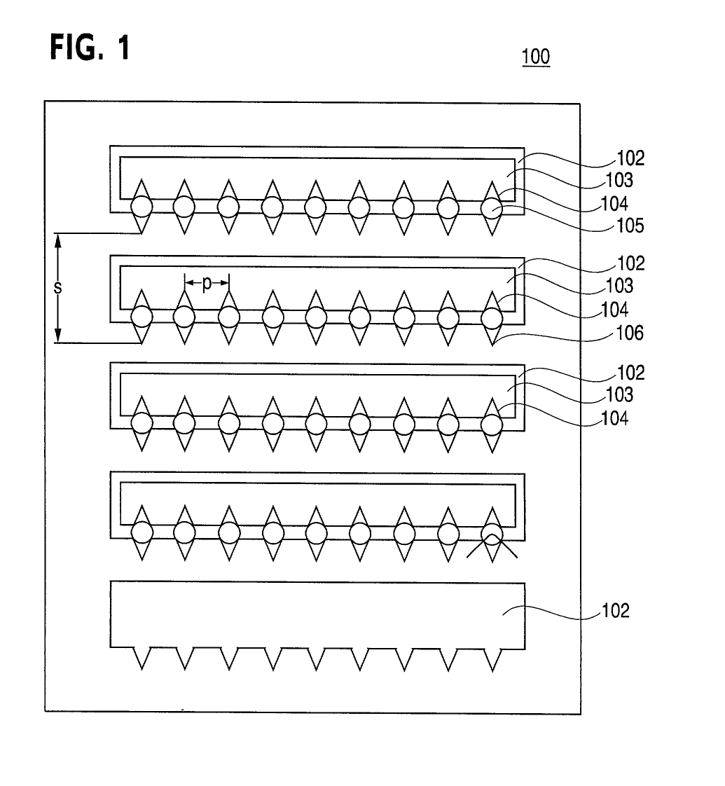

FIG. 1 shows an array 100 of optical fibers according to an exemplary embodiment of the present invention. The array 100 is illustratively a two-dimensional fiber array. A single-piece alignment frame 101 has at least one opening 102 therein. Grooves 106 in the opening(s) 102 may receive optical fibers 105. The grooves 106 are illustratively v-shaped. Each of the openings 102 may receive a waveguide alignment member 103. According to the exemplary embodiment of FIG. 1, the waveguide alignment member 103 includes grooves 104, which are illustratively v-shaped. The grooves 104 of the waveguide alignment member have optical fibers 105 located therein. Illustratively, the waveguide alignment member 103 may be a conventional v-groove fiber array, such as silicon bench v-groove fiber array. The optical fibers 105 may be have buffer layer removed.

In the illustrative embodiment shown in FIG. 1, the waveguide array is a substantially two-dimensional 9×4 array. As can be readily appreciated, the single-piece alignment frame 101 may have “unoccupied” openings, such as shown at the bottom of the single-piece alignment frame 101. The array 100 of the illustrative embodiment shown in FIG. 1 advantageously offers precise pitch (shown as “p”) and spacing (shown as “s”). The accuracy of the pitch results from accurate fabrication of the v-grooves in 104 in the waveguide alignment member 103 as well from accurate fabrication of the grooves 106 in the single-piece alignment frame 101. Accuracy in the spacing “s” between the openings 102 is a direct benefit of the accurate fabrication of the openings 102 in the single-piece alignment frame 101.

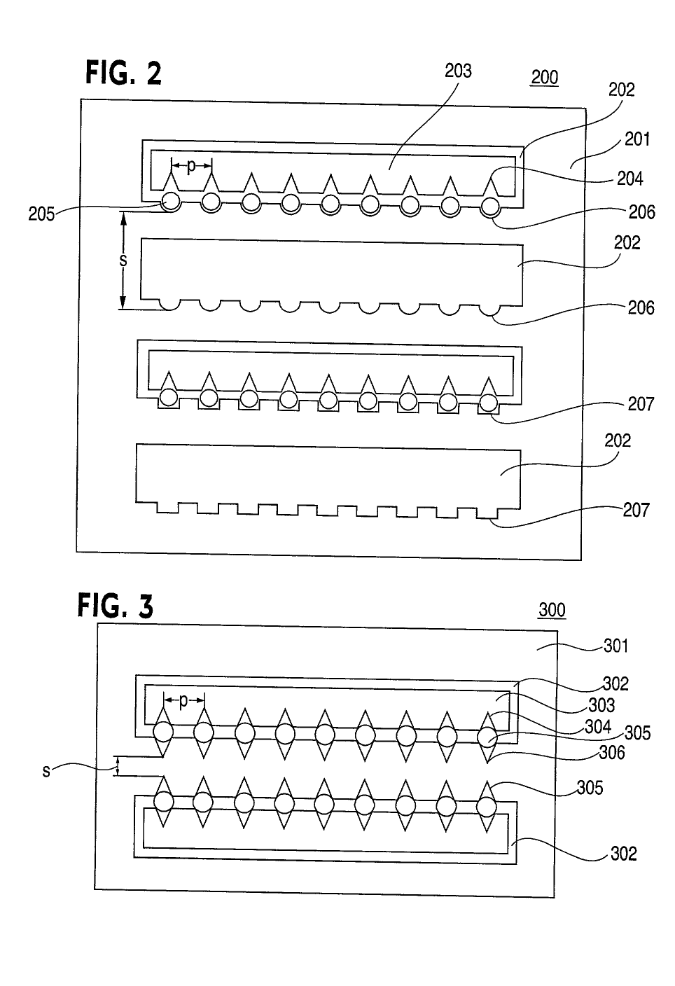

Turning to FIG. 2, another illustrative embodiment of the present invention is shown. An array 200 of optical fibers includes a single-piece alignment frame 201 having openings 202 for reception of waveguide alignment members 203. The waveguide alignment members 203 include grooves 204 which are illustratively v-shaped. While substantially the same as the single-piece alignment frame 101 of the illustrative embodiment of FIG. 1, the single-piece alignment frame 201 includes grooves of varying shapes. For example, grooves 205 are semi-circular, and grooves 206 are substantially square. As in the exemplary embodiment of FIG. 1, the pitch “p”, and spacing “s” are precisely defined. Moreover, the shape of the grooves 206 and 207 may be varied according to user preference.

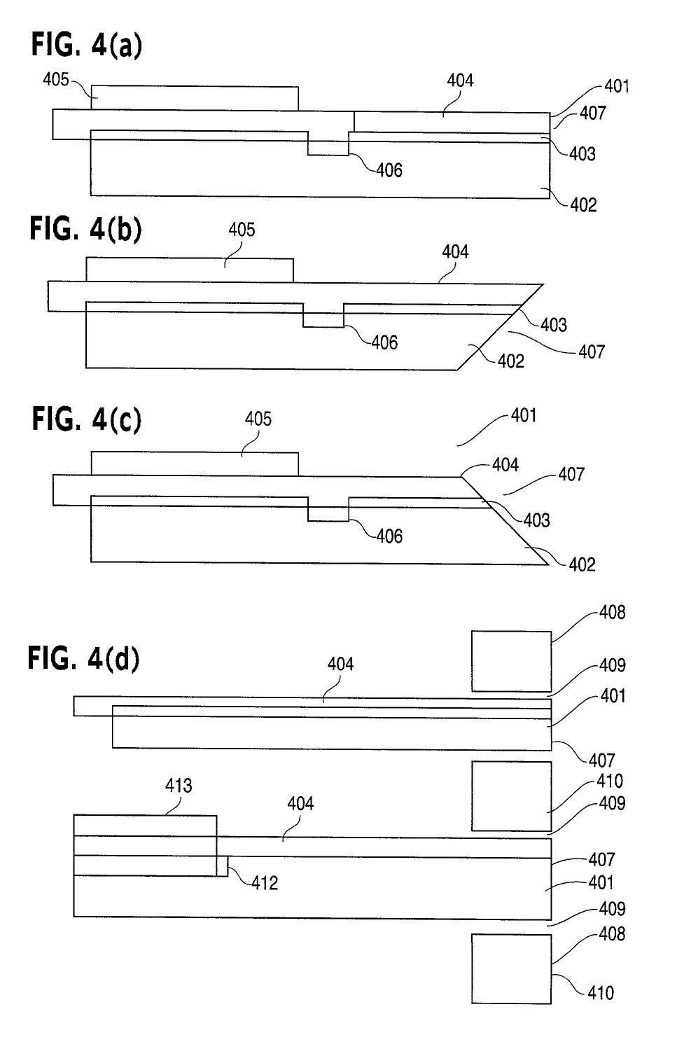

Turning to FIG. 3, another illustrative embodiment of the present invention is disclosed. An optical fiber array 300 includes a single-piece alignment frame 301 having openings 302 and waveguide alignment members 303 disposed in the openings 302. As with the illustrative embodiments of FIGS. 1 and 2, the waveguide alignment members 303 have grooves 304 with optical fibers 305 located therein. Moreover, the single-piece alignment frame 301 has grooves 306. Illustratively, the grooves 304 are v-shaped, although other shapes are possible including, but not limited to, the illustrative shapes of grooves 206 and 207 of FIG. 2. Again, the pitch, “p”, between grooves 304 and 305 and spacing “s”, between openings 302 are accurately defined by virtue of the fabrication techniques used. However, according to the illustrative embodiment of the present invention, the orientation of the v-grooves 305 enables a reduction in the spacing, “s”, between the openings 302. Accordingly, the optical fibers 304 may be more closely spaced, allowing for an improved density of the optical array 300. Again, the single-piece alignment frame 301 may incorporate fewer or more openings 302 then is shown in the illustrative embodiment of FIG. 3.

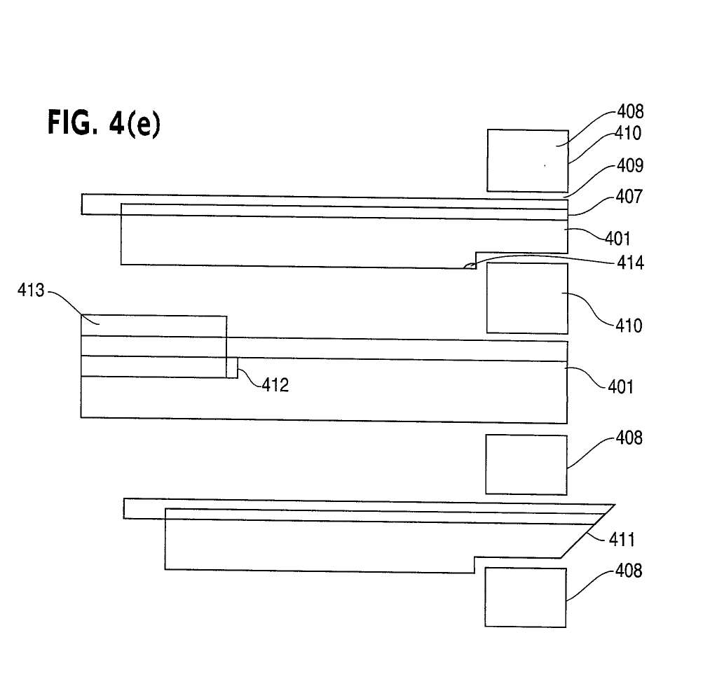

FIGS. 4(a)-4(e) are cross-sectional views of waveguide alignment members having optical fibers 404 therein according to illustrative embodiments of the present invention. FIG. 4(a) shows a waveguide alignment member 401 that includes a substrate 402 having a groove 403 which receives optical fiber 404. A lid 405 is optionally disposed over the optical fiber 404, and may be used to maintain the optical fiber 404 in the groove 403. Moreover, a wick-stop trench 406 is also optionally disposed in the substrate 402. The wick-stop trench 406 is illustratively used to prevent adhesive (for example epoxy) from wicking to the front part of the waveguide alignment member before the waveguide alignment member 401 is disposed in the single-piece alignment frame.

The waveguide alignment member 401 may be made relatively thin to reduce spacing, “s”, between the waveguide alignment members (shown in FIG. 1) and thus between the fibers of the array. The waveguide alignment member 401 may have a thickness of approximately 75 μm to approximately 100 μm. Moreover, the optical fibers 404 may be reduced diameter optical fiber, which can enable reduction in the pitch “p” and spacing “s” (shown in FIG. 1).

In the illustrative embodiments of FIGS. 4(b) and 4(c), the front faces 407 of the waveguide alignment member 401 are angled. As is well known to one of ordinary skill in the art, an angle to the front surface 407 is useful for reducing back reflections as well as for beam steering.

Turning to FIG. 4(d), a cross-sectional view of a waveguide alignment member 401 disposed in a single-piece alignment frame 408 is shown. Although not shown, it is of interest to note that the waveguide alignment member 401 may be inserted into multiple single piece alignment frames arranged in a ‘stacked’ relation. The multiple single piece alignment frames can be spaced apart and planar parallel. The openings in the multiple single piece alignment frames can be aligned so that the waveguide alignment members extend through all the single piece alignment frames. Multiple single piece alignment frames can be used to provide angular alignment for the optical fibers.

The single-piece alignment frame 408 is illustratively substantially identical to the single-piece alignment frames shown in the exemplary embodiments of FIGS. 1-3. The waveguide alignment member 401 is disposed in an opening 409 of single-piece alignment frame 408. The single-piece alignment frame 408 includes grooves (not shown), which receive the optical fibers 404. As can be seen in FIG. 4(d), the endface 407 of the waveguide alignment member 401 is substantially flush with the endface 410 of the single-piece alignment frame 408. One of the waveguide alignment members 401 shown in FIG. 4(d) has a recessed portion 412 for reception of the buffer 413 of the optical fiber 404. The endface 410 of the single-piece alignment frame 408, endface 407 of the waveguide alignment member 401, and the endfaces of the optical fibers 404 are polished in the same polishing step. Thereby, the endface 407 of the waveguide alignment member 401, the endface of the optical fiber 404 and the endface 410 of the single-piece alignment frame 408 are substantially co-planar. As can be readily appreciated, the substantial co-planarity enables a substantially two-dimensional fiber array to be achieved.

FIG. 4(e) shows a side-view of another illustrative embodiment of the present invention in cross-section. The illustrative embodiment shown in FIG. 4(e) is substantially the same as the illustrative embodiment shown in FIG. 4(d). As such like details will be omitted in the interest of brevity. A note-worthy addition to the illustrative embodiment shown in FIG. 4(e) is a recessed edge 414 in waveguide alignment member 401. The recessed edge 414 facilitates accurate alignment of the endface 410 of the single-piece alignment frame 408 with the endface 407 of the waveguide alignment member 401. This fosters the desired co-planarity, although a polishing step may be carried out in a manner similar to that described above. Moreover, while the endface 407 of the waveguide alignment member, the endface 410 of the single-piece alignment frame 408 and the endfaces of the optical fibers 404 may be co-planar; they do not have to be. For example, one of the waveguide alignment members 401 may have an angle polished endface 411. As such, angle polished endface 411 is not substantially co-planar with the endface 410 of the single-piece alignment frame 408.

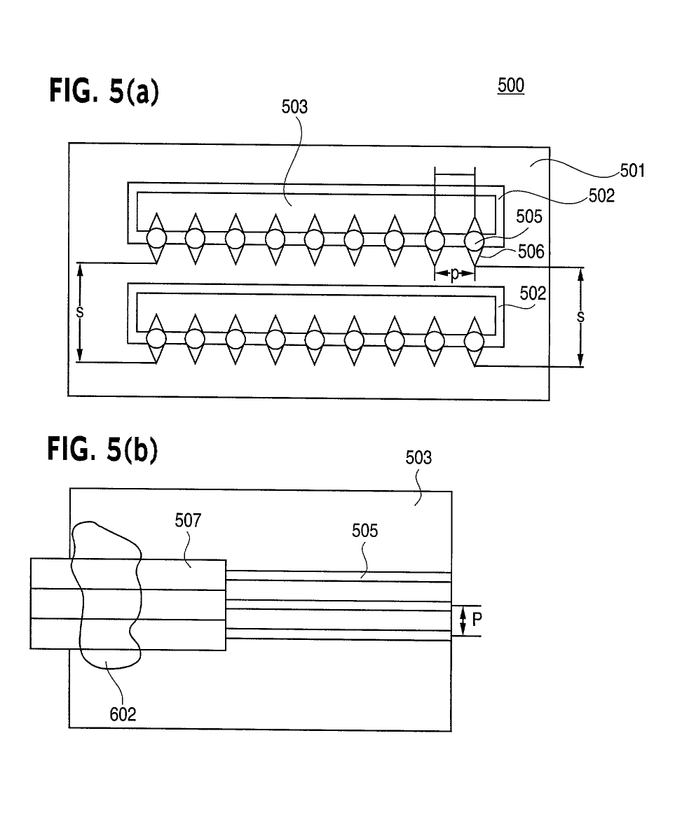

Turning to FIG. 5(a), another illustrative embodiment of the present invention is shown. According to the illustrative embodiment of FIG. 5(a), an optical fiber array 500 includes a single-piece alignment frame 501 having openings 502 therein. Because many of the details of the single-piece alignment frame 501 of the illustrative embodiment of FIG. 5(a) are substantially the same as previously described in connection with the above described exemplary embodiments, these details will be omitted in the interest of brevity. A waveguide alignment member 503 is disposed in the opening 502. The waveguide alignment member 503 is similar to the waveguide alignment members described in connection with the above described exemplary embodiments. However, the waveguide alignment member 503 does not include grooves for reception of the optical fibers 505. The single-piece alignment frame 501 includes grooves 506.

In the illustrative embodiment shown in FIG. 5(a), the alignment of the optical fibers is provided by the center-to-center pitch (shown as “p” in FIG. 5(a)) of the grooves 506, and the spacing between the openings 502 (shown as “s” in FIG. 5(a)). Again, the pitch and spacing of the illustrative embodiment of FIG. 5(a) are substantially the same as described in connection with the above described illustrative embodiments. The relatively flat waveguide alignment member 503 is useful in guiding optical fibers 505 into grooves 506. Waveguide alignment member 503 allows many optical fibers 505 to be inserted in grooves 506 simultaneously.

FIG. 5(b) shows the waveguide alignment member 503 having optical fibers 506 disposed thereon. In the illustrative embodiment of FIG. 5(b), the buffer layers 507 may remain on a portion of the optical fibers 506. A suitable adhesive 602 is disposed over the buffer layers 601. The optical fibers have a pitch “p” (shown in FIG. 5(b)) which substantially matches the pitch “p” of grooves 506 (shown in FIG. 5(a)).

As described above, the grooves 106, 206, 306 and 506 may be of a variety of shapes. As illustrated, these may be v-shaped, semi-circular, or square. Moreover, the illustrative embodiments described above, the optical fibers 105, 205, 305 and 505 are illustratively of circular cross-section. Alternatively, the optical fibers may be polarization maintaining optical fibers. In many instances, polarization maintaining optical fibers are not of substantially circular cross-section. In fact, polarization maintaining optical fibers may have substantially triangular cross-section, D-shaped cross-section or diamond-shaped cross-section. Such non-circular cross-sectional shaped polarization maintaining fibers may be rotationally aligned by the single-piece alignment frames 102, 201, 301 and 501; and/or the waveguide alignment members 103, 203, 303 and 503.

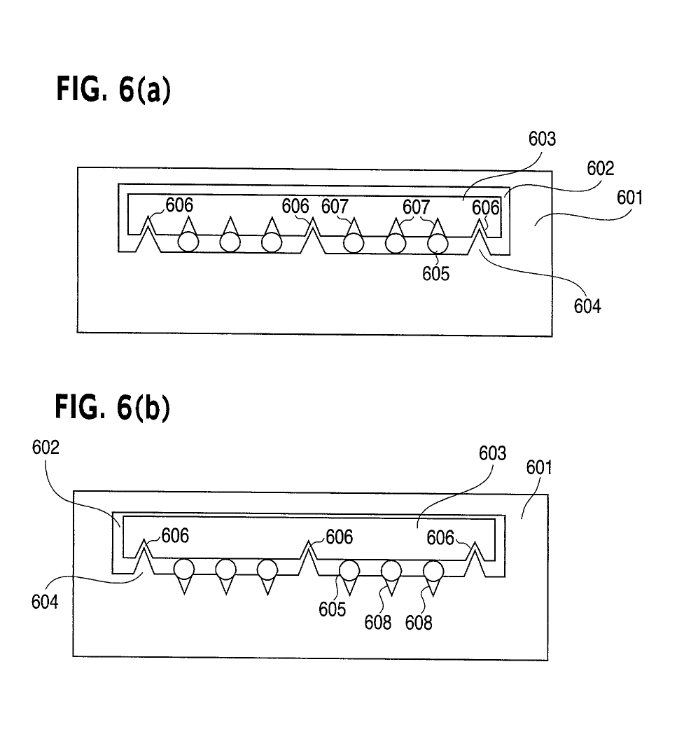

FIG. 6(a) shows another illustrative embodiment according to the present invention. In the illustrative embodiment shown in FIG. 6(a), a single-piece alignment frame 601 includes at least one opening 602 for reception of a waveguide alignment member 603. While in the illustrative embodiment of FIG. 6(a), a single opening 602 is shown for reception of one waveguide alignment member 603, clearly multiple openings for reception of waveguide alignment members 603 may be implemented according to the present invention.

The illustrative embodiment of FIG. 6(a) is similar to the illustrative embodiments described above, but also includes alignment fiducials 604. The alignment fiducials 604 may be formed during the etching process used to fabricate opening 602. Alternatively, the alignment fiducials 604 may be formed subsequently. Moreover, the alignment fiducials 604 may be of different material then that of the single-piece alignment frame. Finally, the alignment fiducials 604 may be separate elements attached to the single-piece alignment frame 601.

Alignment fiducials 604 may be useful in guiding the waveguides 605 into proper position within opening 602. As can be seen in the illustrative embodiment of FIG. 6(a), the alignment fiducials 604 cooperatively engage grooves 606 in the waveguide alignment member 603. These grooves 606 may be similar to grooves 607 which cooperatively receive the waveguides 605. In the illustrative embodiment shown in FIG. 6(a), the opening 602 of the single-piece alignment frame 601 does not include grooves for reception of the optical waveguides. The alignment fiducials 604 provide the alignment of the waveguides 605 by locating the waveguide alignment member 603.

Alternatively, as shown in FIG. 6(b), the waveguide alignment member 603 may not include grooves such as grooves 607 shown in FIG. 6(a). Instead, grooves 608 in the openings 602 of the single-piece alignment frame 601 may be used for reception of optical fibers 605. The alignment fiducials 604 again cooperatively engage grooves 606 in the waveguide alignment member 601 for accurate location of the waveguides 605 within opening 602.

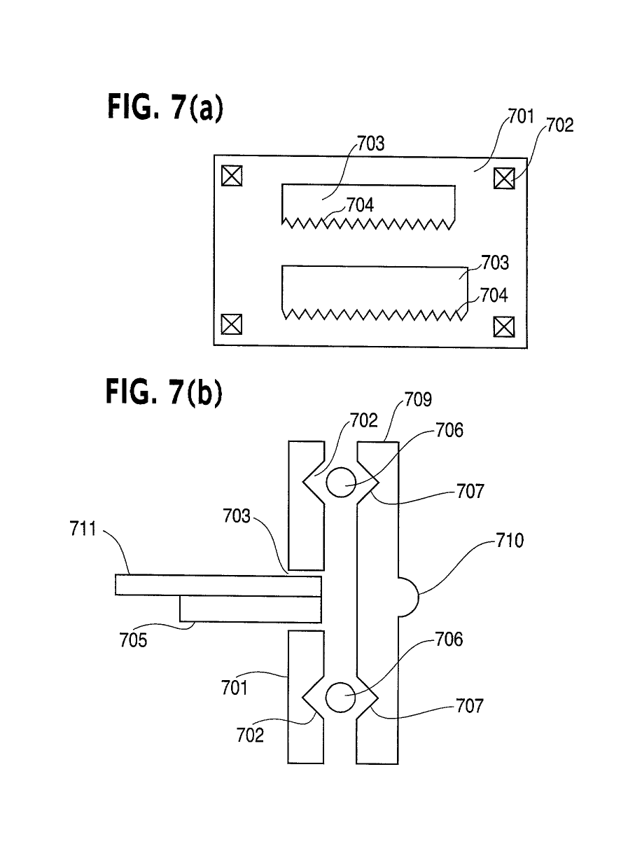

Turning to FIGS. 7(a) and 7(b), another illustrative embodiment according to the present invention is disclosed. In the illustrative embodiment shown in FIG. 7(a), the single-piece alignment frame 701 includes positioning pits 702. The positioning pits 702 are illustratively inverted pyramidal shaped pits resulting from the selective etching of the material used for the single-piece alignment frame 701. For example, according to an illustrative embodiment, the single-piece alignment frame 701 may be fabricated from <100> monocrystalline silicon. Well-known wet-etching techniques may be used to fabricate the inverted pyramidal shape of pits 702. As described previously, opening 703 may receive a waveguide alignment member (not shown in FIG. 7(a)). While the embodiment shown in FIG. 7(a) includes the grooves 704 for reception of optical fibers (not shown in FIG. 7(a)), the single-piece alignment frame 701 may also incorporate features such as alignment fiducials and grooves previously described.

FIG. 7(b) shows a cross-sectional view of a single-piece alignment frame 701 coupled to alignment frame 709. Optical fiber(s) 711 is disposed over waveguide alignment member 705, which is located in opening 703. The Pits 702 receive a positioning member 706, which is illustratively a ball lens or microsphere. The alignment frame 709 may include Pits 707 which cooperatively engage positioning member 706. The alignment frame 709 illustratively includes passive optical elements(s) 710. The passive optical element(s) is illustratively a lens, a filter or a diffractive optical element such as a holographic optical element.

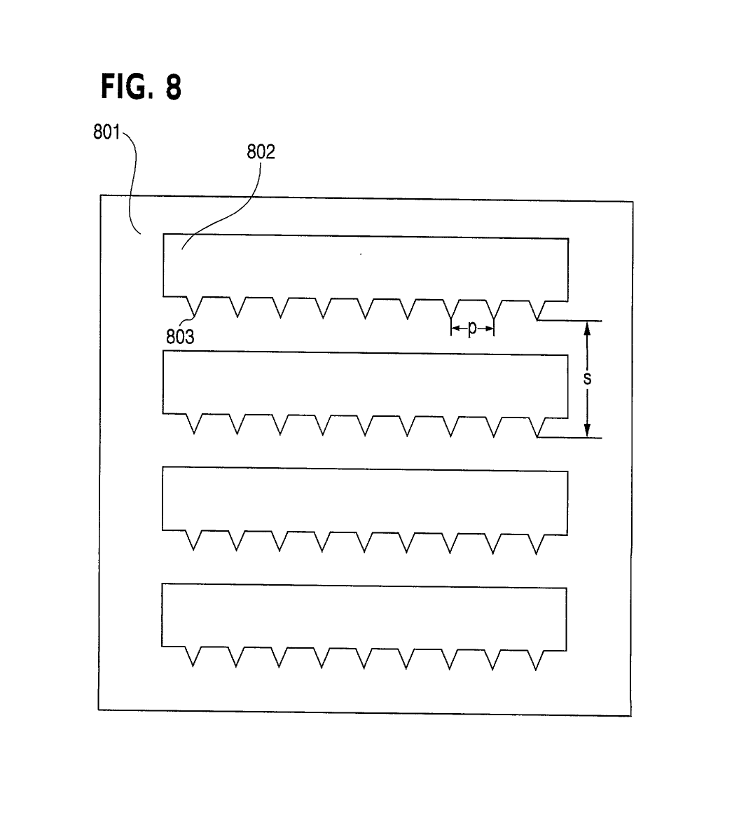

Turning to FIG. 8, a single-piece alignment frame 801 having openings 802 therein is shown. A single-masking step may be carried out in the fabrication of the openings and grooves 803. As referenced above, space “s” between the openings 802 and pitch “p” between the grooves 803 may be accurately defined. Moreover, because the alignment frame is a single piece, and lithography techniques used in carrying out its manufacturer are exceedingly precise, the run-out error which tend to plague the accuracy of alignment of conventional multiple piece alignment frame structures are substantially avoided by virtue of the present invention.

Fabrication of the single-piece alignment frame of the illustrative embodiments described above is effected by well-known fabrication techniques. In the exemplary embodiments described above, the openings in the single-piece alignment frames are made by reactive-ion-etching (RIE) techniques. These techniques are well known to one having ordinary skill in the art. Illustratively, the single-piece alignment frame is made of silicon, silicon-on insulator or other suitable material. Illustratively, the single-piece alignment frame has a thickness on the order of approximately 200 μm to approximately 1500 μm. The reactive-ion-etching technique illustratively used in the fabrication of the single-piece alignment frame results in precision dimensions.

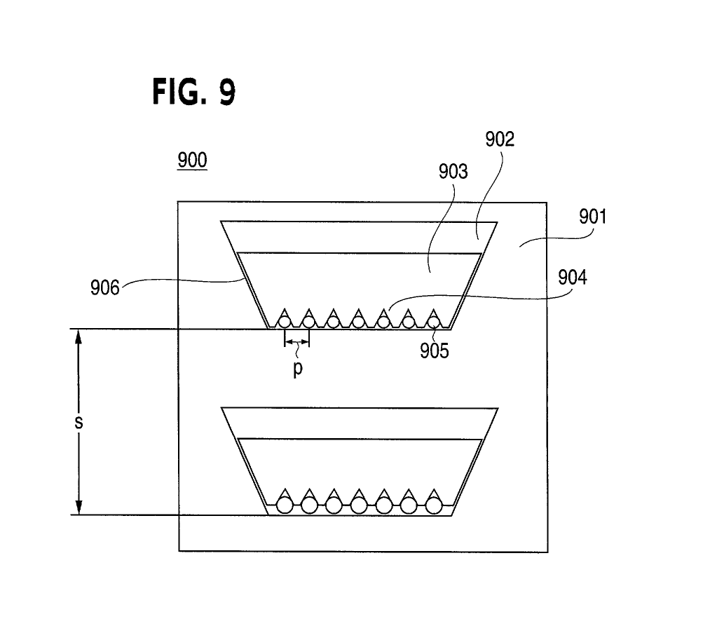

FIG. 9 shows another illustrative embodiment of the present invention. In this illustrative embodiment, a waveguide array 900 includes a single-piece alignment frame 901 having openings 902 therein. A waveguide alignment member 903 has grooves 904 which have optical fibers 905 therein. According to the illustrative embodiment of FIG. 9, the openings 902 do not include alignment fiducials nor grooves. The pitch “p” and spacing “s” are precisely defined as described above.

The openings 902 may have angled edges 906 as show; or they may be substantially rectangular or square. The openings 902 may be formed by known wet or dry etching techniques. Thereby, the known openings 902 are precisely defined and located. The precision in definition and location allows run-out error of conventional structures to be substantially avoided.

The invention having been described in detail in connection through a discussion of exemplary embodiments, it is clear that various modifications of the invention will be apparent to one having ordinary skill in the art having had the benefit of the present disclosure. Such modifications and variations are included within the scope of the appended claims.

We claim:

1. An optical device, comprising:
A single-piece alignment frame having at least one opening, each of said at least one openings having grooves, which receive optical fibers; and
a waveguide alignment member disposed in each of said at least one openings

2. An optical device as recited in claim 1, wherein said grooves are v-shaped.

3. An optical device as recited in claim 1, wherein said grooves are semi-circular.

4. An optical device as recited in claim 1, wherein said grooves are D-shaped.

5. An optical device as recited in claim 1, wherein said grooves are square shaped.

6. An optical device as recited in claim 1, wherein said at least one opening has at least one alignment fiducial disposed therein.

7. An optical device as recited in claim 6, wherein said at least one alignment fiducial is engages another alignment fiducial disposed on said waveguide alignment member.

8. An optical device as recited in claim 1, wherein said waveguide alignment member has at least one optical fiber disposed therein.

9. An optical device as recited in claim 8, wherein each of said at least one optical fibers is disposed in a groove disposed in said waveguide alignment member.

10. An optical device as recited in claim 1, wherein said single-piece alignment frame is a single piece chosen from the group consisting essentially of silicon and silicon-on-insulator.

11. An optical device as recited in claim 1, wherein said optical fibers are polarization maintaining optical fibers.

12. An optical device as recited in claim 1, wherein said waveguide alignment member includes a row of optical fibers.

13. An optical device as recited in claim 1, wherein said single-piece alignment frame couples to another single-piece alignment frame.

14. An optical device as recited in claim 13, wherein said another single-piece alignment frame includes passive optical elements.

15. An optical device as recited in claim 13, wherein said single-piece alignment frame includes pits which receive positioning members.

16. An optical device as recited in claim 13, wherein said passive optical elements are chosen from the group consisting essentially of lenses, filters and diffractive optical elements.

18. An optical device array, comprising:
A single-piece alignment frame having at least one opening, each of said at least one openings having at least one alignment fiducial; and
a waveguide alignment member disposed in each of said at least one openings.

19. An optical device array as recited in claim 18, wherein said each of said waveguide alignment members has a row of optical fibers disposed thereon.

20. An optical device array as recited in claim 18, wherein said waveguide alignment member further includes grooves which receive optical fiber therein.

21. An optical device array as recited in claim 20, wherein said grooves are v-shaped.

22. An optical device array as recited in claim 21, wherein said grooves are semi-circular.

23. An optical device array as recited in claim 22, wherein said grooves are D-shaped.

24. An optical device array as recited in claim 19, wherein said grooves are square shaped.

25. An optical device array as recited in claim 18, wherein at least one alignment fiducial is disposed in said at least one opening.

26. An optical device as recited in claim 18, wherein said single-piece alignment frame is a single piece chosen from the group consisting essentially of silicon, silicon-on-insulator, ceramic and metal.

27. An optical device as recited in claim 19, wherein said optical fibers are polarization maintaining optical fibers.

28. An optical device as recited in claim 18, wherein said alignment frame couples to another single-piece alignment frame.

28. An optical device as recited in claim 28, wherein said another single-piece alignment frame includes passive optical elements.

29. An optical device as recited in claim 29, wherein said passive optical elements are chosen from the group consisting essentially of lenses, filters, isolators and polarizers.

30. An optical device, comprising:
A single-piece alignment frame having at least one opening therein; and
a waveguide alignment member disposed in each of said at least one openings.
